(19) United States
(12) Patent Application Publication
(10) Pub. No.: US 2023/0148291 A1
(43) Pub. Date: May 11, 2023

(54) PROPELLANTLESS PROPULSION SYSTEM AND METHOD

(71) Applicant: Harold Ariel Tavarez, Downey, CA (US)

(72) Inventor: Harold Ariel Tavarez, Downey, CA (US)

(21) Appl. No.: 17/300,784

(22) Filed: Nov. 5, 2021

(51) Int. Cl. H02K 53/00; B64G 1/40; H02K 1/27; F03G 7/10

(52) U.S. Cl. CPC H02K 53/00; B64G 1/409; H02K 1/27; F03G 7/111

(57) ABSTRACT

The present application discloses a propulsion system and method which provides thrust without propellant. The basic propulsion system comprises a means of motion to convey rotary motion to a rotor carrying a rotor magnet generating a magnetic field that interact magnetically with the stationary magnetic field originating in a stator magnet. Magnetic interactions between the moving magnetic field from the rotor magnet travels through the stationary magnetic field space in the stator magnet and generates; a gyroscopic force and a Lorentz force without the ejection of propellant, without reliance on an external mass to react against, and without reaction as recognized in the Newton's Third Law Exception in accordance with the established principles in electrodynamics and modern physics.

### CROSS-REFERENCE TO RELATED APPLICATIONS

The present patent application claims priority from U.S. provisional Application No. 63/205,015 entitled “Propellantless Propulsion System and Method” filed on Nov. 9, 2020, which is incorporated herein by reference in its entirety.

### FEDERALLY SPONSORED RESEARCH

Not Applicable

### SEQUENCE LISTING OR PROGRAM

Not applicable

### BACKGROUND-FIELD

The present application relates to the magneto dynamic interactions between magnetic fields to generate propulsion without propellant and without an external body to react against.

### BACKGROUND-PRIOR ART

Propellantless propulsion is useful for space travel and for means of transportation that travel on land, air, and water. Each of these modes of travel requires a specific type of propulsion.

In that regard, replacing propellant dependent propulsion systems with propellantless propulsion is a more advantageous and an energy efficient approach that will benefit all modes of transportation.

For propulsion, an internal combustion engine with a drive train delivers the power to drive the wheels on a land driven motor vehicle. The ground in contact with the wheels performs the function of the propellant. In aerospace, gas turbine engines rely on air and fuel for propellant. Propellers employ the air and water. While useful for space travel; rocket engines are also limited by the available propellant stored in the rocket.

Practical space drives that generates thrust without propellant for space travel and for propulsion of satellites in orbit; are still a dream not yet fully achieved; but not for the lack of efforts by the workers in the field. All the current modes of propulsion have limited propulsion capabilities due to the limits imposed by the need for propellant.

Examples of propellantless propulsion in the prior art shows;

Purvis U.S. Pat. No. 10,006,446 B2 utilizes multi-element capacitor with segmented rotating cathodes interacting with electromagnetic coils generating magnetic fields.

Purvis U.S. Pat. No. 10,135,323 B2 discloses and apparatus and method for propulsion utilizing capacitor assemblies and electromagnetic Helmholtz coils to generate propellantless thrust. Delroy U.S. Pat. No. 5,090,260 discloses a gyroscopic propulsion system for producing a controlled unidirectional movement in a predetermined direction based on gyrostatic precession.

Rodgers U.S. Pat. No. 5,054,331 is a controllable gyroscopic propulsion apparatus that develop a controllable propulsion force in a desired direction.

Kethley U.S. Pat. No. 4,784,006 discloses a gyroscopic propulsion device that generates a propulsion force with an annular body rotating about the eccentric second axis of the body.

### SUMMARY OF THE INVENTION

The present propulsion system employs a method that generates thrust with the magnetic interactions between magnetic fields such that, with the resultant magneto dynamic field action at a distance generate; gyroscopic forces and Lorentz forces without the ejection of propellant and without reliance of an external body to react against. The basic elements of propulsion are a magnetic field generating rotor and a magnetic field generating stator. The embodiment of the method of propulsion comprises a rotor with single or a plurality of sources of magnetic field; such as permanent magnets and electromagnets generating a magnetic field. The rotor carrying magnet is driven by an electric or a mechanical means of motion to spin the rotor. Gyrations of the rotor and magnet generate a moving magnetic field. The rotor's magnetic field interacts magnetically with a stationary magnetic field. Accordingly, one source of magnetic field is stationary, and the other is in motion.

The invention and method of propulsion employs Newton's Third Law of motion in three simultaneous frames of reference. The first frame is the non-inertial frame of reference of a spinning rotor. A body in motion with acceleration; like a spinning rotor, is a non-inertial frame of reference. As a non-inertial frame of reference, in a rotor, such a cylinder or a disk spinning about its own geometric center of revolution, all the particles in the rotor accelerate toward the center of revolution. The action of an external force on a spinning rotor generates gyroscopic forces in accordance with the principles of gyroscopic operations.

The second frame is an inertial frame of reference. A body at rest or a body in motion at a constant velocity is an inertial frame of reference. A stator comprising a permanent magnet or an electromagnet providing a stationary magnetic field is an inertial frame of reference.

The third frame is a magnetic field frame of reference that employs the Newton's Third Law Exception as known in electrodynamics and modern physics. Each frame of reference cooperates with the other frames in a synergy governed by the laws of physics in that particular frame. The synergy between the frames of reference generates propellantless thrust.

The operation that generates propellantless thrust and propulsion employs; the magnetic forces present in the magnetic fields of permanent magnets and electromagnets to produce gyroscopic forces and Lorentz forces. The gyroscopic forces are induced on a spinning rotor with the magnetic actions(s) at a distance of magnetic fields.

The means to spin a rotor that provides a magnetic field can be an electric motor, mechanical means, or any suitable power source that conveys the spinning rotor and its magnetic field; a predetermined momentum and energy of motion that convey the spinning rotor and its magnetic field with angular momentum and energy of motion. The magnetic field movement traversing the stationary magnetic field generates a magnetic interaction between the stationary magnetic field and the moving magnetic field to produce gyroscopic forces in the rotor, and Lorentz forces in the stator.

In the operation that generates propellantless thrust, the Newton's Third Law action is the motion of the rotor's magnetic field through the magnetic field space of another magnetic field. The magnetic interactions between the magnetic fields generate in the rotor a directional gyroscopic force in accordance with the principles of gyroscopic operation. Simultaneously, the magnetic interaction between the magnetic fields also generates; a directional Lorentz force. The gyroscopic forces and the Lorentz forces are produced without the expulsion of propellant, without an external body to react against, and without an equal and opposite Newton Third Law reaction; as recognized in the Newton's Third Law Exception in agreement with the established principles of electrodynamics and modern physics. In the rotor and the stator, the gyroscopic forces and the Lorentz forces are produced with the action at a distance of magnetic fields. As a method of propulsion, the gyroscopic forces and the Lorentz forces make up the propellantless thrust of propulsion.

The propulsion system disclosed generates propellantless thrust with the input of electric energy to an electric motor as the means that rotates the rotor with the magnets supplying the moving magnetic field. Embodiments of the present invention are novel and distinct in the manner in which the propellantless thrust is produced as a gyroscopic force and a Lorentz force. Engineering analysis and experiments show significant improvements in the thrust level produced with significant lower power consumption Without propellant ejection as compared to other means of propulsion. There is no evidence in the literature and in the prior art pertaining to the manner in which the propellantless thrust is produced, as shown in the disclosed propulsion system and in the operation that generate propellantless thrust.

### BRIEF DESCRIPTION OF THE DRAWINGS

FIG. 1 shows Ampere's discovery on how two orthogonal currents produce an exception to Newton's Third Law between perpendicular currents.

FIG. 2 shows how magnetic interactions between charged particles generate an unbalanced Lorentz force between two charged particles moving orthogonally in the same plane.

FIG. 3 shows how applying a force on the spinning rotor of a gyroscope produces a gyroscopic force that causes the precession of the spinning rotor.

FIG. 4 shows in a plan view an embodiment comprising the essential elements that generate a gyroscopic force and a Lorentz force that comprising the propellantless thrust.

FIG. 5 shows a front view of the propulsion system taken along the lines A-A′ in FIG. 4.

### DETAILED DESCRIPTION OF PREFERRED EMBODIMENTS

FIG. 1

By way of background, initially referring to FIG. 1, about two centuries ago, the French scientist André Marié Ampére discovered several of the scientific principles in the electrical science. One of Ampere findings relates to the forces between perpendicular currents. A first current in one direction exerts a force on a second perpendicular current; while the second current does not exert and equal and opposite force on the first current. This particular discovery by Ampere has been overlooked and ignored in propulsion because reactionless propulsion is thought to be in the realm of the impossible.

FIG. 1 shows Ampere's discovery in connection to orthogonal or perpendicular currents. In a current segment 10, a current flows in a vertical direction. While in a current segment 12, positioned in a horizontal and perpendicular direction to the current segment 10; a second current I₂ flows horizontally and perpendicular to the first current I₁. In this setup, the current I₁ generates a force 14 on the current segment 12. While the current I₂; does not exert an equal and opposite force on the current segment 10. Accordingly, the force dF₁ on the current segment 10 originating from the current I₂ in the current segment 12 is zero (dF₁=0). The equal and opposite reaction commanded by Newton's Third Law (NTL) is absent. Ampere's discovery relating the forces between perpendicular currents is a Newton's Third Law Exception (NTLE).

In current electrodynamics and modern physics, the force 14 is recognized as a Lorentz force and appears to be a violation to Newton's Third Law (NTL). Ampere's discovery has been overlooked and ignored in propulsion because is only applicable to isolated current segments. When all the forces produced by electric currents in complete circuits are taken into account, NTL is satisfied. And that explains why electric appliances such as computers, televisions, radios and the like; do not propel themselves with the electric currents in the circuit.

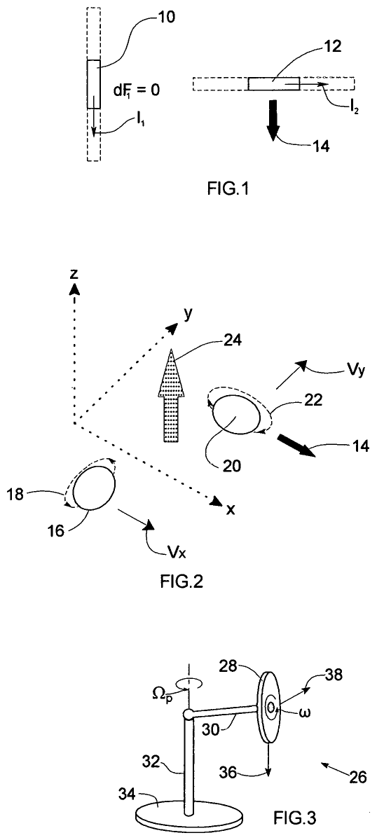

FIG. 2

FIG. 2 shows two coplanar particles moving at right angle to each other. It is well known by those skilled in the art that a charged particle 16 (electron or proton) moving with velocity V_{X} parallel to the x-axis as shown, will exerts a force on another charged particle 20 moving orthogonally on the same plane parallel to the y-axis with velocity V_{y}.

It is also known in the art that a particle makes a magnetic field along its line of motion. And in the line of motion, particle 16 makes a magnetic field 18. Similarly, in its line of motion, charged particle 20 makes a magnetic field 22. Because the movement of charged particle 20 is perpendicular to the path of charged particle 16; the magnetic field 22 of particle 20 is also perpendicular to the magnetic field 18 of charged particle 16.

As FIG. 2 illustrates, particle 20 is in an orthogonal line of motion in relation to particle 16 and in the path of movement of magnetic field 18; inducing on particle 20 a magnetic field 24 parallel to the z-axis. The magnetic interactions between particle 16 with magnetic field 18 and particle 20 with magnetic field 22; generates the induced magnetic field 24 that also generates a Lorentz force 14. In this orthogonal magnetic interaction between particles and fields, particle 16 applies a force on particle 20. While particle 20 does not apply and equal and opposite reaction force on particle 16 contrary to the postulates of Newton's Third Law (NTL) “For every action there is an equal and opposite reaction.” This exception to NTL is well known, well studied and well understood by those skilled in the art and is part of electrodynamics and modern physics. NTLE takes place in the magnetic field frame of reference. The Newton's Third Law Exception (NTLE) is one situation the present propulsion system and method exploits and takes advantage of to engineer a practical and useful propellantless prime mover.

It is well established that, the magnetic fields of permanent magnets and energized electromagnets have North (N) and South (S) magnetic poles that interact magnetically in accordance to the polarity and orientation of the poles. As a general rules, unlike magnetic poles attract each other, and like poles repel each other. In addition, the magnetic fields of permanent magnets and electromagnets in an orthogonal arrangement can produce a full NTLE effect that generate propellantless thrust for propulsion as disclosed herein the application.

FIG. 3

By way of additional background, FIG. 3 shows a gyroscope 26 comprising a disk shape rotor 28 mounted for rotation on a shaft 30 spinning counterclockwise with the angular velocity ω. The shaft 30 is also pivotally mounted for rotational precession at a precession velocity Q, about a vertical shaft 32 mounted on a base 34.

The spinning rotor 28 is a non-inertial frame of reference. In a gyroscope, in the direction of rotation, an input force 36, acting on the rotor 28; generates an output force 38 at a position ninety degrees ahead the input force 36. The output force 38 generates a torque that causes the gyroscope rotor 28 to gyrate about the shaft 32 with the precession angular velocity Ωₚ. In a gyroscope, the input force can be an external force or the force of gravity that simultaneously generates and output force at about ninety degrees ahead the input force in the direction of rotation. The resultant output force is perpendicular to the input force. Similarly, the output force 38 has a vector force direction perpendicular to the input force 36.

For exemplification, FIG. 3 shows the rotor 28 under the influence of the input force 36 generating the gyroscopic output force 38. The input force 36 can be the force of gravity, an external force, the force of a physical contact, or the force of; an external magnetic field acting from a distance on the rotor 28. The operation of the gyroscope 26 shows the output force 38 prompting the gyroscopic precession about the shaft 32 with the precession velocity Ωₚ. The magnitude of the output force 38 is a byproduct of the input force 36, the rotor 28 moment of inertia, the angular velocity ω, and the radius of gyration between the vertical shaft 32 and the rotor 28. The radius of gyration for the gyroscope 26 is the shaft 30.

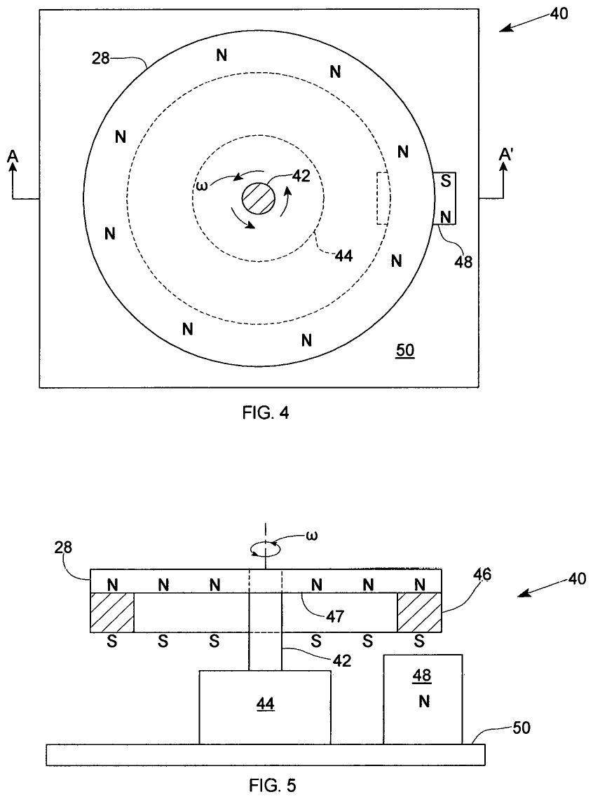

FIG. 4 & FIG. 5

FIG. 4 is a top view of the propulsion components that generate propellantless thrust. FIG. 5 is a front view taken along FIG. the line A-A′ in FIG. 4. Both FIG. 4 and FIG. 5 show the essential elements that exploit the synergy in the operation of the gyroscope 26; together with NTLE to engineer a practical and useful propellantless prime mover for propulsion.

FIG. 4

FIG. 4 show a propulsion system 40 comprising the disk shaped rotor 28 mounted on the shaft 42 of a means of motion 44, a rotor magnet 46, a stator magnet 48, and a frame 50. The rotor magnet 46 is an annulus of predetermined dimensions comprising an inner radius at a predetermined distance from the center of the rotor 28, and extends towards the periphery for a predetermined distance. The rotor magnet 46 is mounted on the rotor 28 underside 47. One side of the magnet 46 is shown with the letter N symbolizing the magnetic North pole; and the opposite side of the magnet 46 is the South magnetic pole S to indicate the N-S magnetic field vector direction (best shown in FIG. 5). The rotor 28 is shown with arrows to indicate the counterclockwise spin direction with the angular velocity ω. The stator magnet 48 is shown the letters N-S to indicate the North-South magnetic vector direction of the stationary magnetic field that originates in the stator magnet 48. Mounted on the frame 50 are the means of motion 44 and the stator magnet 48. The frame 50 serves as a structure for attachment to the vehicle to which the propulsion system 40 provides thrust for propulsion.

FIG. 5

FIG. 5 is a front section view taken along the line A-A′ in FIG. 4 showing the rotor 28 attached to the shaft 42 of the means for motion 44. The annular rotor magnet 46 has the top surface marked as the magnetic North Pole N while the rotor magnet 46 bottom is the South Pole S, a stator magnet 48 generating a stationary magnetic field showing the North magnetic pole N, and the frame 50 as a structural member to attach the propulsion system 40 to a vehicle for propulsion. The means of motion 44 and the stator magnet 48 can be mounted on the frame 50 with suitable means of attachment.

The propulsion system 40 generates a propellantless propulsion force comprising the vector sum of the gyroscopic output force 38 and the Lorentz force 14 produced by the gyrations of the rotor 28 carrying the rotor magnet 46 while interacting magnetically with the stationary N-S magnetic field vector originating in the stator magnet 48.

FIG. 5 shows that the N-S magnetic field vector direction for the rotor magnet 46 is parallel to the shaft 42. In contrast to the rotor magnet 46, the stator rotor 48 N-S magnetic field vector is perpendicular to rotor magnet 46 N-S magnetic field vector. The perpendicular magnetic fields arrangement achieves the maximum NTLE effects to achieve propellantless propulsion.

Even though, the orthogonal orientation between magnetic fields is the optimal angular orientation; nevertheless, for applications in numerous embodiments, the magnetic fields can also be disposed in a number of angular orientations in addition to the orthogonal alignment between the fields.

In regards to the action at a distance between magnetic fields and magnets, the magnetic field strength and therefore the intensity decreases or increases inversely proportional to the square of the distance from the source. FIG. 5 shows with the rotor magnet 46 placed adjacent to and in close proximity to the stator magnet 48. There is a predetermined distance of separation between the rotor magnet 46 and the stator magnet 48 that predetermines the magnetic interaction intensity between the moving magnetic field from the rotor magnet 46 and the stationary magnetic field of the stator magnet 48. Accordingly, the closer or the smaller the separation distance between the stator magnet 48 and the rotor magnet 46, the stronger the magnetic field interaction strength that yields a higher propellantless thrust output by the propulsion system 40.

In the context of the definition for magnet as used in the description for the rotor magnet 46 and stator magnet 48, the descriptive magnet refers to a body, a material, a device, or a machine capable of generating a magnetic field, such as a permanent magnet, an electromagnet, or a superconducting magnet.

As in all magnetic field agents, the forces of magnetic attraction and repulsion are present in the propulsion system 40. And as a general rule, like magnetic poles repel. While unlike magnetic poles attract. Moreover, the alignment between the magnetic fields between the rotor magnet 46 and the stator magnet 48 are angularly disposed at convenient and suitable predetermined angles that include the orthogonal angles to obtain a maximum NTLE effect. Accordingly, the magnetic fields of both, the rotor magnet 46 and the stator magnet 48 are shown with the letters N and S to indicate magnetic poles. The symbol N stand for the North magnetic pole; and the symbol S stand for the South magnetic pole.

Operation

A charged particle in motion through a magnetic field experiences a force directly dependent on the velocity of the particle through the magnetic field and the sine of the angle between the particle velocity and the field. The resultant force on the particle is perpendicular to both the field and the particle velocity through the field. This principle is also applicable to the operation that generates propellantless thrust in the propulsion system 40. The same principle is also equally applicable to the motion of the magnetic fields of permanent magnets and electromagnets in motion through another magnetic field.

The force of a particle moving through a magnetic can be measured as a Lorentz force proportional to the charge of the particle, the vector cross product of the particle velocity and the sine of the angle between the particle path and the magnetic field at the particle location. Similarly, the motion of the magnetic field originating in the rotor magnet 46, in motion through the stationary magnetic field originating in the stator magnet 48; also generates a Lorentz force 14. The magnitude of the Lorentz force 14 produced during the period of magnetic interaction between the rotor magnet 46 and the stator magnet 48 is equally proportional to the magnitude of the magnetic fields from the rotor magnet 46 and the stator magnet 48 in terms of magnetic field intensity, inversely proportional to the separation distance between the fields of the rotor magnet 46 and the magnet stator 48, the angular orientation between the magnetic fields, and the vector cross product of the velocity at which the rotor magnet 46 magnetic field moves through the stator magnet 48 stationary magnetic field space, and the sine of the angle between the corresponding magnetic fields. The resultant Lorentz force 14 is perpendicular to both, the magnetic fields originating in the rotor magnet 46 and the stator magnet 48.

In the propulsion system 40, the motion of the rotor 28 spinning with the angular velocity ω, together with the N-S magnetic field originating in the rotor magnet 46; acts as a moving magnetic field that interacts magnetically with the stationary magnetic field in the stator magnet 48. As an axis of reference, the N-S magnetic field with origin in the magnet 46 is parallel to the shaft 42. Similarly, for maximum NTLE effect, the N-S stationary magnetic field with origin in the stator magnet 48; is orthogonal to the rotor magnet 46 magnetic field. As an embodiment, the means of motion 44 is an electric motor to produce the rotary motion that conveys the rotor 28 and the rotor magnet 46 with angular momentum and energy of motion.

Electric motors as articles of commerce convert electricity to rotary motion made available as a torque to rotate the rotor 28; for conversion to the angular momentum and rotary energy of motion that generate the gyroscopic force 38, and the directional Lorentz force 14 with the magnetic interactions between the magnetic fields of the spinning rotor magnet 46, and the stationary magnetic field originating in the stator magnet 48. In this embodiment, the propulsion system 40 converts electricity to propellantless thrust. Additional means for motion such as gas turbines and other means are equally applicable for applications in alternate embodiments to generate propellantless propulsion.

The embodiment disclosed is shown with a single annular magnet 46 on the rotor 28 for magnetic interaction with a singular stator magnet 48. However, additional embodiments of the propulsion system 40 can be built with a plurality of magnet segments on the rotor 28 to generate the magnetic field(s) that interact with the stator magnet to generate propellantless thrust. Similarly, the stator magnet 48 can be built with as an assembly of a plurality of magnets to interact with the moving magnetic field from the rotor magnet 46.

In an electromagnetic mode, the construction of the rotor magnet 46 can be practiced as an assembly of coils segments in a cylindrical arrangement with the supporting electric circuits to generate magnetic fields of predetermined magnetic intensities that cooperate and interact magnetically with the stationary magnetic field originating in the stator magnet 48. However, the inclusion of the electric power supply to the electromagnets is not shown since those skilled in the art can design and implement the electric circuits as known in the art.

In the operation of the rotor 28 spinning together with the rotor magnet 46, the magnetic fields interaction between the stator magnet 48 and the rotor magnet 46; generate the Lorentz force 14 and the gyroscopic output force 38. The vector sum of these two forces generates a propellantless propulsion force. The magnetic interaction simultaneously act as the gyroscopic input force 36 that generate the gyroscopic output force 38, and also generate the Lorentz force 14. The motion of the rotor magnet 46 has a momentum and energy of motion commensurate with the rotor 28 angular velocity ω.

The motion of the rotor magnet 46 magnetic field traversing through the stator magnet 48 magnetic field; generates in the propulsion system 40, the gyroscopic force 38 and the Lorentz force 14 without an equal and opposite reaction, without the expulsion of propellant, and without reliance on an external mass to react against in accordance to the principles of NTLE.

NTLE is well known, well established, and is part of electrodynamics and modern physics. The Lorentz force 14 and the gyroscopic force 38 is the situation the present method of propulsion exploits to engineer the propulsion system 40 to generate propellantless thrust for propulsion.

The propulsion system 40 is a suitable propulsion assembly to provide propulsion for on land, air, water, on orbit and space traveling vehicles. Some examples of transportation vehicles are cars, vans, buses, trucks, aircrafts, naval ships, submarines, satellites in orbit, and spaceships for space travel. Those skilled in art can in effect design the appropriate and suitable means to supply the power to operate the propulsion system 40 to generate the thrust of propulsion. With the method of operation herein described, the propulsion system 40 can convert electricity to thrust. The sources of electric power and connections for the electric motor(s) and for the electromagnets can be made in accordance with the known standards and technology available at the time of implementation.

The propulsion system 40 shows the essential elements as a model for an embodiment (among many) employed to carry out a variety of experiments to test for propellantless thrust successfully. The tests were done with commercially available electric motors and a plurality of Neodymium permanent magnets on a rotor mounted on the motor's shaft. Together with a single and a plurality of stationary Neodymium magnet(s) mounted on a frame. The assembled test components were mounted on a platform with roller ball bearing casters to allow for the platform free movement of the platform in any direction. The supporting electronics to control the motor speed, and the three phase motor(s) used; is of the type commonly found in hobby type drones and model airplanes powered by LiPo batteries.

### CONCLUSIONS, RAMIFICATIONS, AND SCOPE

The propulsion system disclosed is a novel prime mover utilizing a method of magnetic interactions between; a magnetic field in motion through a stationary magnetic field. By way of magnetic field action at a distance, the magnetic interactions between the fields generate gyroscopic forces and Lorentz forces that become the thrust of propulsion without propellant.

The novel propulsion system is adaptable to employ means of motion such as an electric motor, an internal combustion engine with a transmission, or a gas turbine to spin a single or a plurality of rotors with permanent magnets or electromagnets to convey the magnetic fields of permanent magnet(s) and electromagnet(s), with an angular momentum and energy of motion to generate propellantless thrust. The propellantless thrust can be produced with the magnetic interactions between a single or a plurality of magnetic fields in motion through the magnetic space of a single or a plurality of stationary magnetic fields.

Accordingly, the teachings above can be carried out in the form multiple embodiments with the derivatives and permutations of the principle disclosed in accordance with the precepts of magnetic fields interactions.

Additional embodiments comprise the use of Halbach arrays of permanent magnets and electromagnets in the rotor that generate a moving magnetic field, and in the stator that provide the stationary magnetic field.

The spinning rotor can be assembled to include a Halbach array of permanent magnets; or a Halbach array of electromagnets. Similarly, the stator or the stationary source of magnetic field also may include a Halbach array arrangement of permanent magnets and/or electromagnets. The particular embodiment may also be carried out as a combination of a single or a plurality of Halbach arrays rotors interacting magnetically with a single or a plurality of Halbach array stators.

The embodiment disclosed operates with a novel method of propulsion that generates thrust without the expulsion of propellant, and without reaction with the exception to Newton's Third Law in accordance with established principles of modern physics. The thrust is produced by the magnetic interaction between two or more magnetic fields. When one magnetic field has momentum and energy of motion and moves through the magnetic space of another magnetic field, the magnetic interactions between the fields generate directional gyroscopic forces and directional Lorentz forces.

The propulsive gyroscopic and Lorentz forces are a byproduct of magnetic fields interactions; consequently, the magnitude of the propellantless thrust output can be considerably increased and enhanced with superconductivity. Considerable high magnitude gyroscopic forces and Lorentz forces can be achieved with superconducting magnets. With superconductivity, propellantless propulsion by way of NTLE will increase many times over to a level of magnitude that may not be obtainable with ordinary permanent magnets and electromagnets. The construction of the present embodiment with superconducting magnets; is a big step in progress that will increase the magnitudes of the magnetic fields and the magnitude of the enhanced NTLE effect, and therefore, the magnitude of the obtainable propellantless thrust available for propulsion.

As the reader can see from a reading of the disclosure, the present embodiment can be carried out and built with commercially available components such as permanent magnets, electromagnets, electric motors, and electronic components to construct the supporting electronic circuits. Electric energy for an electric motor as a means of motion for a rotor and the electromagnets the generate the magnetic fields for the magnetic interactions that generate the gyroscopic forces and the Lorentz forces for propulsion can be supplied with commercially available batteries, fuel cells, solar cells, and other suitable power supplies.

The present embodiment has been described with reference to the accompanying drawings with like numbers referring to like elements throughout the descriptions. The embodiments may be represented in many different forms and should not be construed as limitations. Additional embodiments are possible without departing from the teachings set forth in the disclosure. Rather, these embodiments are provided so that the disclosure will be thorough and complete, and will convey the full scope of the invention,

I claim:

1. A propulsion system, comprising:
a means of motion as source of angular momentum and energy of motion for a rotor,
a rotor magnet generating a magnetic field mounted on said rotor,
a stator magnet generating a magnetic field to interact magnetically with the rotor's magnetic field,
wherein said means of motion convey angular momentum and rotational energy of motion at a predetermined angular velocity to said rotor carrying said rotor magnet generating a magnetic field to interact magnetically with a stator magnet generating a magnetic field, wherein said rotor as a source of magnetic field interact magnetically with said stator magnetic field to generate a gyroscopic force and a Lorentz force for propulsion.

2. The propulsion system in claim 1 wherein said means for motion is an electric motor to convey rotational energy to said rotor carrying said rotor magnet.

3. The propulsion system in claim 1 wherein said rotor magnet is a permanent magnet.

4. The propulsion system in claim 1 wherein said stator magnet is a permanent magnet.

5. The propulsion system in claim 1 wherein said rotor magnet is an electromagnet.

6. The propulsion system in claim 1 wherein said stator magnet is an electromagnet.

7. A method of propulsion, comprising:
providing a means for motion to convey angular momentum and rotational energy of motion to a rotor at a predetermined angular velocity,
providing a rotor magnet as a source of magnetic field mounted on said rotor,
providing a stator magnet as a source of magnetic field generating a stationary magnetic field,
wherein said means of motion convey rotational energy to said rotor carrying said rotor magnet as a source of magnetic field at a predetermined angular velocity to interact magnetically with said stationary stator magnet generating a stationary magnetic field to generate a gyroscopic force and a Lorentz force for propulsion.

8. The method of propulsion in claim 7 wherein said means for motion is an electric motor to convey rotational energy to said rotors.

9. The method of propulsion in claim 7 wherein said magnet in said rotor is a permanent magnet.

10. The method of propulsion in claim 7 wherein said magnet in said rotor is an electromagnet.

11. The method of propulsion in claim 7 wherein said magnet in said stator is a permanent magnet.

12. The method of propulsion in claim 7 wherein said magnet in said stator is an electromagnet.

13. A propulsion method, comprising:
providing means of motion to supply angular momentum and energy of motion to a rotor,
providing a rotor magnet to generate a magnetic field mounted on said rotor,
providing a stator magnet to generate a magnetic field to interact magnetically with said rotor's magnetic field,
wherein said means of motion convey angular momentum and energy of motion at a predetermined angular velocity to said rotor carrying said rotor's magnet supplying a magnetic field to interact magnetically with the magnetic field of said stator, wherein said rotor's magnetic field interact magnetically with said stator's magnetic field to generate a gyroscopic force and a Lorentz force.

14. The propulsion method in claim 13 wherein said means of motion is an electric motor.

15. The propulsion method in claim 13 wherein said rotor magnet is a permanent magnet.

16. The propulsion method in claim 13 wherein said rotor magnet is an electromagnet.

17. The propulsion method in claim 13 wherein said stator magnet is a permanent magnet.

18. The propulsion method in claim 13 wherein said stator magnet is an electromagnet.
